(19) United States
(12) Patent Application Publication
(10) Pub. No.: US 2024/0284257 A1
(43) Pub. Date: Aug. 22, 2024

(54) Jitter Management

(71) Applicant: Telefonaktiebolaget LM Ericsson (PUBL), Stockholm (SE)

(72) Inventors: Torsten DUDDA, Wassenberg (DE); Dhruvin PATEL, Aachen (DE); Joachim SACHS, Sollentuna (SE)

(21) Appl. No.: 18/568,947

(22) PCT Filed: Jun. 11, 2021
(86) PCT No.: PCT/EP2021/065776

§ 371 Date: Dec. 11, 2023

(51) Int. Cl. H04W 28/10; H04L 47/283

(52) U.S. Cl. CPC H04W 28/10; H04L 47/283

(57) ABSTRACT

Methods (100, 300) and apparatus (400, 500) are provided. In an example aspect, a method (100) performed by a receiver (400) of receiving packets is provided. The method (100) comprises receiving (102) packets, wherein each packet includes an identifier that identifies a respective group of a plurality of groups, buffering (104) the packets in a buffer, and delivering (106) the packets from the buffer to a higher layer or application. Delivering (106) the packets to a higher layer or application comprises delivering each packet in a delivery time period associated with the group identified by the identifier of the packet.

### TECHNICAL FIELD

Examples of the present disclosure relate to transmitting and/or receiving packets.

### BACKGROUND

The fifth generation technology standard for cellular wireless communication networks, also referred to as 5G or New Radio (NR), may in some implementations be capable of fulfilling ultra-reliable low latency communication (URLLC) requirements. For example, such communications may have low latency in the range of 1 ms with high reliability or likelihood of successful transmission and reception, e.g. 99.999% reliability. This may be particularly useful for certain applications, including industrial and Internet of Things (IoT) use-cases such as motion control and process automation.

There are several components in a Radio Access Network (RAN) that could lead to unforeseen delays for transmitting a unit of data such as a packet. For example, transmissions on the radio interface, the RAN scheduler may decide when to transmit a packet over the air, in order to efficiently multiplex the transmission with transmissions from other services or users. This may lead to queuing delays for the packet. Furthermore, depending on when the packet is made available for transmission (e.g. created), transmission of the packet may need to wait until the next transmission slot. That is, for example, there may be a frame alignment delay. Transmissions over the air may also fail to be successfully received by a receiver, and retransmission may be necessary, introducing additional delays. In the receiver, delays to packet processing or delivery may occur, such as reordering of received packets to ensure in-order delivery.

The 3rd Generation Partnership Project (3GPP) 5G standard specification Release 16, with the aim to support time sensitive networking (TSN) integration, supports time synchronization between a base station (gNB) and a User Equipment (UE). The 5G capability introduced when integrating the 5G system (5GS) and TSN networks is to provide 5G internal clock (reference time) delivery to the device side TSN translator (DS-TT). An absolute reference time delivery mechanism had been developed, which enables UE and gNB to have same time reference (e.g. in 3GPP TS 38.331 V16.4.1, which is incorporated herein by reference). The 5G internal clock (reference time) provides the 5G reference clock for 5GS internal synchronization within the gNB and UE.

### SUMMARY

One aspect of the present disclosure provides a method performed by a receiver of receiving packets. The method comprises receiving packets, wherein each packet includes an identifier that identifies a respective group of a plurality of groups, and buffering the packets in a buffer. The method also comprises delivering the packets from the buffer to a higher layer or application. Delivering the packets to a higher layer or application comprises delivering each packet in a delivery time period associated with the group identified by the identifier of the packet.

Another aspect of the present disclosure provides a method of transmitting packets. The method comprises obtaining packets for transmission, wherein each packet is obtained in one of a plurality of time periods, and transmitting the packets to a receiver such that each packet includes an identifier that identifies a respective group of a plurality of groups. Each group is associated with a respective one of the time periods.

A further aspect of the present disclosure provides apparatus for receiving packets. The apparatus comprises a processor or processing circuitry and a memory. The memory contains instructions executable by the processor such that the apparatus is operable to receive packets, wherein each packet includes an identifier that identifies a respective group of a plurality of groups, buffer the packets in a buffer, and deliver the packets from the buffer to a higher layer or application. Delivering the packets to a higher layer or application comprises delivering each packet in a delivery time period associated with the group identified by the identifier of the packet.

A still further aspect of the present disclosure provides apparatus for transmitting packets. The apparatus comprises a processor or processing circuitry and a memory. The memory contains instructions executable by the processor such that the apparatus is operable to obtain packets for transmission, wherein each packet is obtained in one of a plurality of time periods, and transmit the packets to a receiver such that each packet includes an identifier that identifies a respective group of a plurality of groups. Each group is associated with a respective one of the time periods

An additional aspect of the present disclosure provides apparatus for receiving packets. The apparatus is configured to receive packets, wherein each packet includes an identifier that identifies a respective group of a plurality of groups, buffer the packets in a buffer, and deliver the packets from the buffer to a higher layer or application. Delivering the packets to a higher layer or application comprises delivering each packet in a delivery time period associated with the group identified by the identifier of the packet.

Another aspect of the present disclosure provides apparatus for transmitting packets. The apparatus is configured to obtain packets for transmission, wherein each packet is obtained in one of a plurality of time periods, and transmit the packets to a receiver such that each packet includes an identifier that identifies a respective group of a plurality of groups, wherein each group is associated with a respective one of the time periods.

In another aspect, a computer program is provided. The computer program comprising instructions which, when executed on at least one processor, cause the at least one processor to carry out a method according to any of the aforementioned methods.

In another aspect, a carrier containing a computer program according to the previous aspect is provided. The carrier may comprise one of an electronic signal, optical signal, radio signal or computer readable storage medium.

In another aspect, a computer program product comprising non transitory computer readable media is provided. The product having stored thereon a computer program comprising instructions which, when executed on at least one processor, cause the at least one processor to carry out a method according to any of the aforementioned methods.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 is a flow chart of an example of a method, performed by a receiver, of receiving packets;

FIG. 2 illustrates an example of how the method of FIG. 1 is performed;

FIG. 3 is a flow chart of an example of a method of transmitting packets;

FIG. 4 is a schematic of an example of an apparatus for receiving packets;

FIG. 5 is a schematic of an example of an apparatus for transmitting packets;

FIG. 6 shows an example of a communication system according to an example of this disclosure;

FIG. 7 shows an example of a communication system in accordance with some embodiments; and

FIG. 8 shows a communication diagram of a host communicating via a network node with a UE over a partially wireless connection in accordance with some embodiments.

### DETAILED DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

The non-deterministic delays that a packet or data may experience between being made available for transmission at a transmitter and being delivered to a destination (e.g. an application or higher layer) at a receiver may cause jitter between the transmitter and receiver. How to provide deterministic latency, i.e. no jitter, when using wireless communications such as those according to the 5G system is currently unclear. That is, for example, how to ensure a fixed periodicity of packet delivery is currently unclear. Applications requiring low jitter, or applications that cannot sustain varying or sporadically large inter-arrival times of packets cannot currently be supported.

Embodiments of this disclosure may provide a solution to these and other problems. For example, embodiments of this disclosure may provide deterministic periodical inter-delivery times at a receiver based on playout buffering. One or more examples disclosed herein may improve the periodicity of communications transmitted wirelessly and thereby provide benefits such as fewer communication dropouts or error conditions, etc. As a result, applications or use cases that require deterministic latency or transmission times may use communication systems, such as wireless communication systems e.g. 4G or 5G systems. Applications requiring low jitter, or applications that cannot sustain varying or sporadically large inter-arrival times of packets may be supported.

In some examples of this disclosure, a deterministic inter-delivery time, that is, a periodical delivery of packets to an application or higher layer, is enabled based on a playout buffer. It is assumed in some examples that there is some desired periodicity in the traffic. For example, an industrial application might expect to receive a burst of packets at predetermined periodical occasions, where each burst may include a varying number of packets in some examples. Applications may determine that the underlying communication system is operating correctly only if the inter-reception times of the packets are below a threshold. The application may declare failures if the inter-reception times of the packets is above a threshold.

In particular examples, there is an assumption that traffic is periodical. That is, for example, there are one or more packets per time period that need to be delivered at a certain point in time once per time period. The points in time can be pre-configured for the receiver, for example as an absolute time offset and the period lengths. When a packet is received and identified as being associated with a particular time period (which may be conveyed for example by identifying a group for the packet), it is buffered and delivery is delayed until the pre-configured delivery time for this period. Examples may ensure that queueing, reordering and transmission time for packets is never higher than the period. In this way, each packet can be identified as being associated with a certain time period. In some examples, for traffic with multiple and/or varying size of packets per period, a flag indicating belonging to a certain period can be included in the PDCP header at the transmitter. This flag can be considered as a burst or time period identifier. This may be for example a one-bit flag, which is toggled for packets belong to the next time period. Whether packets belong to the next period is identified at the transmitter based on the time when they are obtained for transmission. The transmitter may thus for example use a similar windowing or periodical pattern to identify to which period that each packet is associated with.

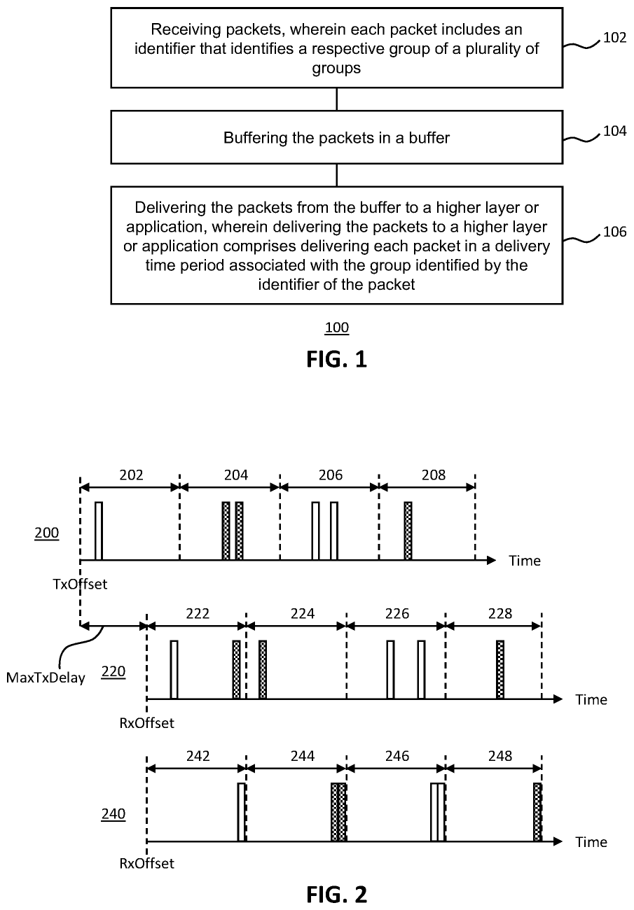

FIG. 1 is a flow chart of an example of a method 100, performed by a receiver, of receiving packets. The method may be performed by a wireless terminal or User Equipment for example, or alternatively the method may be performed by a base station (e.g. eNB or gNB) or an access point. The method 100 comprises, in step 102, receiving packets, wherein each packet includes an identifier that identifies a respective group of a plurality of groups. In some examples, the identifier may be included within a Packet Data Convergence Protocol, PDCP, header of the packet, although in other examples the identifier may be conveyed in any other suitable manner, such as for example elsewhere in the packet header or in a data payload of the packet. Step 104 of the method 100 comprises buffering the packets in a buffer. Step 106 comprises delivering the packets from the buffer to a higher layer or application, wherein delivering the packets to a higher layer or application comprises delivering each packet in a delivery time period associated with the group identified by the identifier of the packet.

FIG. 2 shows an illustration of an example of how the method 100 may be performed. At a transmitter 200, packets are obtained. That is, for example, each packet is obtained in one of a plurality of time periods. FIG. 2 shows four time periods 202, 204, 206 and 208 as an example, although in other examples there may be any number of time periods (also in some examples the time periods may repeat indefinitely). Time is shown on the horizontal axis. In the example shown, each time period has the same duration. Each packet obtained for transmission is represented by a vertical bar. In the first time period 202, one packet is obtained, in the second time period 204, two packets are obtained, in the third time period 206 two packets are obtained and in the fourth time period 208 one packet is obtained. The vertical bars representing the packets obtained in time periods 204 and 208 are shaded for clarity. The number of packets obtained in each time period is merely an example, and in other examples, any number of packets (including no packets) may be obtained in each of the time periods. The time periods associated with the plurality of groups may be different.

The packets are transmitted to a receiver 220. As explained above, each packet may experience an unknown delay, and thus arrive at the receiver at unknown times and even in some examples in a different order than the order in which they were obtained for transmission at the transmitter 200. The packets are shown as being received at the receiver 220 in a plurality of time periods 222, 224, 226 and 228, where in the example shown the time difference between the start of the first time period 202 at the transmitter and the start of the first time period 222 at the receiver may correspond to an expected transmission delay for a packet This expected transmission delay may correspond to the actual time taken to transmit a packet from the transmitter to the receiver, and/or may include for example a duration for propagation through the transmission medium as well as coding at the transmitter 200, decoding at the receiver 200 etc, but not including unexpected delays due to for example retransmissions, packet reordering or frame alignment delay. This delay is referred to in the example shown in FIG. 2 as MaxTxDelay.

As shown in the example in FIG. 2, the delays to the packets vary, such that they are not received a fixed time after they are obtained for a transmission, and in some cases a packet obtained in one time period may even arrive at the receiver 220 in the same time period as a packet obtained in a different time period. For example, time period 222 in the receiver receives packets from time periods 202 and 204 at the transmitter. Thus for example there is jitter in the packets as they are received, and this jitter will be passed on to a higher layer or application if the packets are delivered to the higher layer or application as soon as they are received.

In some examples of this disclosure, the problem of jitter or the varying transmission time delay between packets may be mitigated or eliminated by including an identifier in each packet that identifies a respective group of a plurality of groups. In some examples, the identifier may identify a time period in the transmitter (e.g. time period 202, 204, 206 or 208) in which the packet is obtained. The packets are then delivered to a higher layer or application by delivering each packet in a delivery time period associated with the group identified by the identifier of the packet. That is, for example, packets made available in the same group at the transmitter, such as group 204 in FIG. 2, are delivered in the same time period at the receiver. This may also reorder packets that are received out of order in some examples. FIG. 2 also shows an example of a delivery procedure 240 in the receiver 220 such that each packet in a delivery time period associated with the group identified by the identifier of the packet. As shown in this example, packets obtained in time period 202 at the transmitter 200 are delivered in time period 242 at the receiver, packets obtained in time period 204 are delivered in time period 244 at the receiver, packets obtained in time period 206 are delivered in time period 246 at the receiver, and packets obtained in time period 208 are delivered in time period 248 at the receiver. In some examples, the time periods 222, 224, 226 and 228 correspond to the time periods 242, 244, 246 and 248 (e.g. they have the same start times and durations). Additionally or alternatively, in some examples, the time periods 242, 244, 246 and 248 have the same duration as the time periods 202, 204, 206 and 208 at the transmitter.

By delivering each packet in a delivery time period associated with the group identified by the identifier of the packet, this may reduce or eliminate at least some of the variance between obtaining the packet at the transmitter and delivering the packet at the receiver. In some examples, each packet is delivered at a predetermined time within the time period associated with the group, or at an end of the time period associated with the group. In FIG. 2, for example, the delivery 240 of the packets occurs at the end of the respective time period. For example, packets created in time period 204 at the transmitter 200 are delivered to an application or higher layer at the end of time period 244.

The start of the first time period 202 at the transmitter 200 is referred to in the example shown as TxOffset. The value of TxOffset may be for example an absolute time or an offset from an absolute (e.g. pre-configured) time, or may be another time reference or offset from the other time refence. In some examples, the transmitter and receiver may share the same reference time, which may be configured. In such examples, the transmitter may configure the receiver (or the receiver may configure the transmitter of the packets, for example where the receiver is a base station in the case of uplink packets) with a time, referred to for example as RxOffset. This is particularly relevant for uplink transmissions where the network node would configure the UE with a TX offset—according to the internal wanted rxoffset. The value of RxOffset may be for example an absolute time or an offset from an absolute (e.g. pre-configured) time, or may be another time reference or offset (e.g. MaxTxDelay) from the other time refence such as TxOffset.

In some examples of the method 100, the identifier of a packet identifies a time period during which the packet was obtained for transmission at a transmitter of the packet. An example is illustrated in FIG. 2, where packets delivered in time period 242 in the receiver 220 were obtained for transmission in time period 202 at the transmitter 200. Similarly, packets delivered in time period 244 in the receiver 220 were obtained for transmission in time period 204 at the transmitter 200.

In some examples, there are a finite number of group identifiers, and the group identifiers repeat periodically. That is, for example, the group identifier assigned to packets in each time period may cycle once the maximum number of group identifiers is reached. In a particular example, there may be four groups, numbered 1 to 4, and the group identifier assigned in each successive time period may follow the pattern 1, 2, 3, 4, 1, 2, . . . . In another example, there may be two groups, and the group identifier may follow the pattern 1, 2, 1, 2, 1, 2, . . . . In other words, in some examples, the plurality of groups include a first group, and the method comprises receiving one or more packets a predetermined length of time after the delivery time period associated with the first group, and delivering the packets to the higher layer or application in a further delivery time period later than the delivery time period associated with the first group. The examples given here are merely illustrative examples, and each group may be identified using any other number (including non-consecutive numbers) and/or other identifiers. In particular examples, the plurality of groups comprise only a first group and a second group, wherein the first group is associated with a first delivery time period and the second group is associated with a second delivery time period. Such examples may only need a single bit to represent the identifier, with the value of the bit being different for successive time periods, e.g. the sequence 0, 1, 0, 1, 0, 1, . . . .

In some examples, the duration of each time period at the transmitter, e.g. the duration of the time periods 242, 244, 246 and 248 in FIG. 2, is fixed, for example pre-programmed in the receiver or specified by a communication standard specification. Alternatively, for example, the duration may be configured, for example by receiving a configuration from the transmitter, a base station or other node. In another example, the duration may be associated with a particular application with which the packets being transmitted are associated. In another example, the receiver may transmit a configuration of the time periods to the transmitter, such that for example the transmitter subsequently assigns groups to transmitted packets according to time periods of the configured duration. Additionally or alternatively, a configuration of a start time or offset of one or more of the delivery time periods may be similarly configured. For example, one or more of the values of TxOffset, RxOffset and/or MaxTxDelay may be configured by the transmitter to the receiver (or alternatively from the receiver to the transmitter, for example where the receiver of the packets is a base station in the case of uplink transmissions).

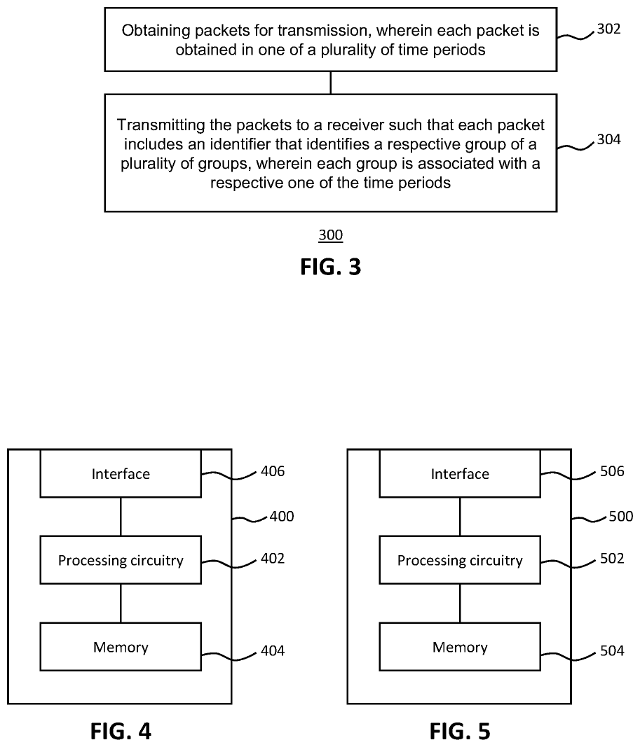

FIG. 3 is a flow chart of an example of a method 300 of transmitting packets. The method may be performed by a wireless terminal or User Equipment for example, or alternatively the method may be performed by a base station (e.g. eNB or gNB) or an access point. The method 300 comprises, in step 302, obtaining packets for transmission, wherein each packet is obtained in one of a plurality of time periods. The time periods may correspond for example to those time periods 202, 204, 206 and 208 shown in the example implementation in FIG. 2. The packets may be obtained for example from an application or higher layer in a transmitter 200. Step 304 of the method comprises transmitting (e.g. wirelessly) the packets to a receiver such that each packet includes an identifier that identifies a respective group of a plurality of groups, wherein each group is associated with a respective one of the time periods. In some examples, the identifier may be included within a Packet Data Convergence Protocol, PDCP, header of the packet, although in other examples the identifier may be conveyed in any other suitable manner, such as for example within a data payload of the packet. In some examples, the method 300 is performed by a transmitter of packets whereas the method 100 is performed by a receiver of those packets.

In some examples, the plurality of groups comprise only a first group and a second group, wherein the first group is associated with a first one of the time periods and the second group is associated with a second one of the time periods. Similar to corresponding examples of the method 200, such examples may only need a single bit to represent the identifier, with the value of the bit being different for successive time periods, e.g. the sequence 0, 1, 0, 1, 0, 1, . . . .

In some examples, which may correspond to examples of the method 100 above, the method 300 may comprise transmitting, to the receiver, a configuration of a duration of delivery time periods for delivering the packets to a higher layer or application in the receiver. Alternatively, for example, the method 300 may comprise receiving, from the receiver, a configuration of a duration of delivery time periods for delivering the packets to a higher layer or application in the receiver. The duration of the delivery time periods may for example correspond to a duration of the plurality of time periods in which the packets are available for transmission. Additionally or alternatively, a configuration of a start time or offset of one or more of the delivery time periods may be similarly configured. For example, one or more of the values of TxOffset, RxOffset and/or MaxTxDelay may be configured by the transmitter to the receiver (or alternatively from the receiver to the transmitter, for example where the receiver of the packets is a base station in the case of uplink transmissions).

In a particular example, a transmitter identifies to which period each packet is associated (e.g. in which period each packet is obtained for transmission), and labels them accordingly using a group identifier. This is included in the packet, e.g. in the packet header. The receiver may receive those packets with variable delays that potentially lead to out of order receptions. Also, packets labeled to be transmitted in one period might be received within a subsequent period in the receiver due to variable delays. In some examples, the duration of each time period is assumed to be known for the traffic, and is configured equally for both transmitter and receiver. The point in time when packets are delivered by the play-out buffer may be determined by the offset RxOffset, which may also be configurable. Thus, for example, packets associated with period x are delivered at RxOffset+x*period duration, or may be delivered during the time period identified in this manner, for example at the end of the time period. In some alternative examples, RxOffset may be determined as the time at which a first packet is received (e.g. the first packet for a particular flow or application).

For example, delivery of packets in a receiver may be configured to occur at RxOffset+n*period, where both RxOffset and period would be configured, or during or at the end of a time period that begins at RxOffset+n*period, where period is the duration of a time period (e.g. time periods 222-228 or 242-248 at the receiver). This may be performed in some examples by a network node such as a base station, for example based on IEEE 802.1Qbv. Alternatively this may be determined by an application in the receiver for example, or may be set arbitrarily. In some examples, RxOffset may be defined as an absolute time according to a certain clock, which could in some examples be same as an offset to a start of a clock. e.g. 12:05. Then, for example, the network node could configure a UE (which may be the transmitter or receiver of packets) to always deliver at “5 past”, e.g. 12:05, 13:05, 14:05 when configuring the offset 12:05 and period=1 hour. In some examples, the network node and UE share the same clock or have synchronized clocks.

For some traffic types and applications, the exact delivery offsets (e.g. RxOffset+x*period duration referred to above) may be known and can be preconfigured (e.g. using IEEE 802.1Qbv). Also the TxOffset may be known and can be configured directly (e.g. IEEE 802.1Qci). For other traffic types and applications, these values may not be known. It may be the case that exact delivery offsets are not critical for those traffic types and applications, it is only the inter-arrival determinism that matters. In this case, in some examples the offset RxOffset can be determined in the receiver itself, based on reception of the first packet. In this case the receiver would not be configured with rxoffset but determine it, e.g. rxoffset=time of received first packet. Then afterwards, delivery of subsequent packets would happen at this rxoffset+n*period. So the first packet determines the offset. Alternatively, for example, RxOffset can be configured for the receiver by the transmitter. In this case, the transmitter determines TxOffset and calculates RxOffset as TxOffset plus maxTxDelay. This is particularly useful in certain scenarios such as for example downlink communications, where a base station such as an eNB or gNB configures RxOffset for the receiving UE. For uplink communications, for example, the base station (which is the receiver) may configure TxOffset for the UE, based on its determination of the RxOffset, for example RxOffset minus the expected transmission delay MaxTxDelay.

In certain examples, such as the case of 5G-TSN integrated deployment, the desired inter-reception or inter-delivery time may be obtained from the application via Time Sensitive Communication Assistance Information (TSCAI) and configured by a base station such as an eNB or gNB to the UE. TSCAI according to the 3GPP TS 23.501 specification V17.0.0, which is incorporated herein by reference, describes TSC traffic characteristics for use in the 5G system. In examples of this disclosure, this information it can be used for configuring packet delivery. For example, TSCAI traffic pattern information may include periodicity of communication streams, from which inter-reception time (e.g. durations of time periods in the receiver) can be calculated.

FIG. 4 is a schematic of an example of an apparatus 400 for receiving packets (e.g. comprising or comprised in a receiver). In some examples the apparatus 400 comprises processing circuitry 402 (e.g. one or more processors) and a memory 404 in communication with the processing circuitry 402. The memory 404 contains instructions executable by the processing circuitry 402. The apparatus 400 also comprises an interface 406 in communication with the processing circuitry 402. Although the interface 406, processing circuitry 402 and memory 404 are shown connected in series, these may alternatively be interconnected in any other way, for example via a bus.

In one embodiment, the memory 404 contains instructions executable by the processing circuitry 402 such that the apparatus 400 is operable to receive packets, wherein each packet includes an identifier that identifies a respective group of a plurality of groups, buffer the packets in a buffer, and deliver the packets from the buffer to a higher layer or application. Delivering the packets to a higher layer or application comprises delivering each packet in a delivery time period associated with the group identified by the identifier of the packet. In some examples, the apparatus 400 is operable to carry out the method 100 described above with reference to FIG. 1. The apparatus 400 may comprise or be comprised in a wireless device (e.g. UE) or a base station (e.g. gNB).

FIG. 5 is a schematic of an example of an apparatus 500 for transmitting packets (e.g. comprising or comprised in a transmitter). In some examples the apparatus 500 comprises processing circuitry 502 (e.g. one or more processors) and a memory 504 in communication with the processing circuitry 502. The memory 504 contains instructions executable by the processing circuitry 502. The apparatus 500 also comprises an interface 506 in communication with the processing circuitry 502. Although the interface 506, processing circuitry 502 and memory 504 are shown connected in series, these may alternatively be interconnected in any other way, for example via a bus.

In one embodiment, the memory 504 contains instructions executable by the processing circuitry 502 such that the apparatus 500 is operable to obtain packets for transmission, wherein each packet is obtained in one of a plurality of time periods, and transmit the packets to a receiver such that each packet includes an identifier that identifies a respective group of a plurality of groups, wherein each group is associated with a respective one of the time periods. In some examples, the apparatus 500 is operable to carry out the method 300 described above with reference to FIG. 3.

In some examples a computer program comprising instructions which, when executed on at least one processor, cause the at least one processor to carry out a method according to any of methods or embodiments disclosed herein. The processor may be, for example processing circuitry as described within apparatus 400 or 500.

In some examples a carrier contains the aforementioned computer program wherein the carrier may be for example an electronic signal, optical signal, radio signal or computer readable storage medium (e.g. memory 404, 504).

In some examples a computer program product may be used for storing the aforementioned computer program instructions. Such a product may comprise non transitory computer readable media having stored thereon the computer program. A memory (404, 504) may be such a product but also a disk or hard drive are other non-limiting examples.

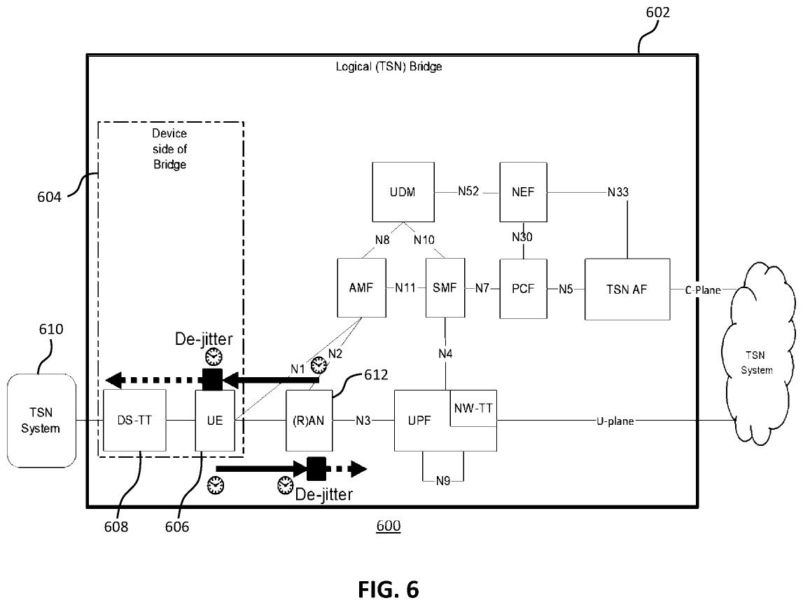

FIG. 6 shows an example of a communication system 600, such as a 5G communication system, according to an example of this disclosure. The communication system 600 includes at least some components and interconnections defined by the 5G standard specification. In the example communication system 600 shown, a logical (TSN) bridge 602 includes a device side of bridge 604, which in turn includes a UE 606 that is connected to DS-TT 608. The DS-TT is in communication with TSN system 610. The UE 604 may also communicate with Radio Access Network (RAN) 612, via a network node such as a base station for example. In some examples, the UE 606 may include de-jitter capability to receive packets in accordance with examples disclosed herein, such as for example the method 100 of FIG. 1. Accordingly, the RAN 612 may transmit packets according to examples of this disclosure, such as for example the method 300 of FIG. 3. Additionally or alternatively, in some examples, the RAN 612 (e.g. network node or base station) may include de-jitter capability to receive packets in accordance with examples disclosed herein, such as for example the method 100 of FIG. 1. Accordingly, the UE 606 may transmit packets according to examples of this disclosure, such as for example the method 300 of FIG. 3.

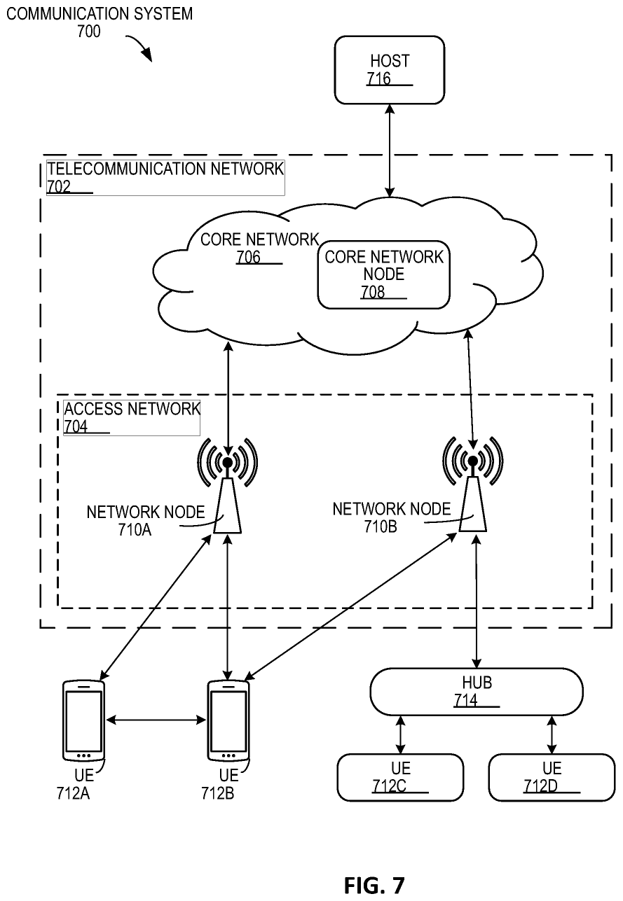

FIG. 7 shows an example of a communication system 700 in accordance with some embodiments. In the example, the communication system 700 includes a telecommunication network 702 that includes an access network 704, such as a radio access network (RAN), and a core network 706, which includes one or more core network nodes 708. The access network 704 includes one or more access network nodes, such as network nodes 710a and 710b (one or more of which may be generally referred to as network nodes 710), or any other similar 3rd Generation Partnership Project (3GPP) access node or non-3GPP access point. The network nodes 710 facilitate direct or indirect connection of user equipment (UE), such as by connecting UEs 712a, 712b, 712c, and 712d (one or more of which may be generally referred to as UEs 712) to the core network 706 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 700 may include any number of wired or wireless networks, network nodes, UEs, and/or any other components or systems that may facilitate or participate in the communication of data and/or signals whether via wired or wireless connections. The communication system 700 may include and/or interface with any type of communication, telecommunication, data, cellular, radio network, and/or other similar type of system.

The UEs 712 may be any of a wide variety of communication devices, including wireless devices or terminals arranged, configured, and/or operable to communicate wirelessly with the network nodes 710 and other communication devices. Similarly, the network nodes 710 are arranged, capable, configured, and/or operable to communicate directly or indirectly with the UEs 712 and/or with other network nodes or equipment in the telecommunication network 702 to enable and/or provide network access, such as wireless network access, and/or to perform other functions, such as administration in the telecommunication network 702.

In the depicted example, the core network 706 connects the network nodes 710 to one or more hosts, such as host 716. These connections may be direct or indirect via one or more intermediary networks or devices. In other examples, network nodes may be directly coupled to hosts. The core network 706 includes one more core network nodes (e.g., core network node 708) that are structured with hardware and software components. Features of these components may be substantially similar to those described with respect to the UEs, network nodes, and/or hosts, such that the descriptions thereof are generally applicable to the corresponding components of the core network node 708. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 716 may be under the ownership or control of a service provider other than an operator or provider of the access network 704 and/or the telecommunication network 702, and may be operated by the service provider or on behalf of the service provider. The host 716 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance centre, or any other such function performed by a server.

As a whole, the communication system 700 of FIG. 7 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 702 is a cellular network that implements 3GPP standardized features. Accordingly, the telecommunications network 702 may support network slicing to provide different logical networks to different devices that are connected to the telecommunication network 702. For example, the telecommunications network 702 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 712 are configured to transmit and/or receive information without direct human interaction. For instance, a UE may be designed to transmit information to the access network 704 on a predetermined schedule, when triggered by an internal or external event, or in response to requests from the access network 704. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 714 communicates with the access network 704 to facilitate indirect communication between one or more UEs (e.g., UE 712c and/or 712d) and network nodes (e.g., network node 710b). In some examples, the hub 714 may be a controller, router, content source and analytics, or any of the other communication devices described herein regarding UEs. For example, the hub 714 may be a broadband router enabling access to the core network 706 for the UEs. As another example, the hub 714 may be a controller that sends commands or instructions to one or more actuators in the UEs. Commands or instructions may be received from the UEs, network nodes 710, or by executable code, script, process, or other instructions in the hub 714. As another example, the hub 714 may be a data collector that acts as temporary storage for UE data and, in some embodiments, may perform analysis or other processing of the data. As another example, the hub 714 may be a content source. For example, for a UE that is a VR headset, display, loudspeaker or other media delivery device, the hub 714 may retrieve VR assets, video, audio, or other media or data related to sensory information via a network node, which the hub 714 then provides to the UE either directly, after performing local processing, and/or after adding additional local content. In still another example, the hub 714 acts as a proxy server or orchestrator for the UEs, in particular in if one or more of the UEs are low energy IoT devices.

The hub 714 may have a constant/persistent or intermittent connection to the network node 710b. The hub 714 may also allow for a different communication scheme and/or schedule between the hub 714 and UEs (e.g., UE 712c and/or 712d), and between the hub 714 and the core network 706. In other examples, the hub 714 is connected to the core network 706 and/or one or more UEs via a wired connection. Moreover, the hub 714 may be configured to connect to an M2M service provider over the access network 704 and/or to another UE over a direct connection. In some scenarios, UEs may establish a wireless connection with the network nodes 710 while still connected via the hub 714 via a wired or wireless connection. In some embodiments, the hub 714 may be a dedicated hub—that is, a hub whose primary function is to route communications to/from the UEs from/to the network node 710b. In other embodiments, the hub 714 may be a non-dedicated hub—that is, a device which is capable of operating to route communications between the UEs and network node 710b, but which is additionally capable of operating as a communication start and/or end point for certain data channels.

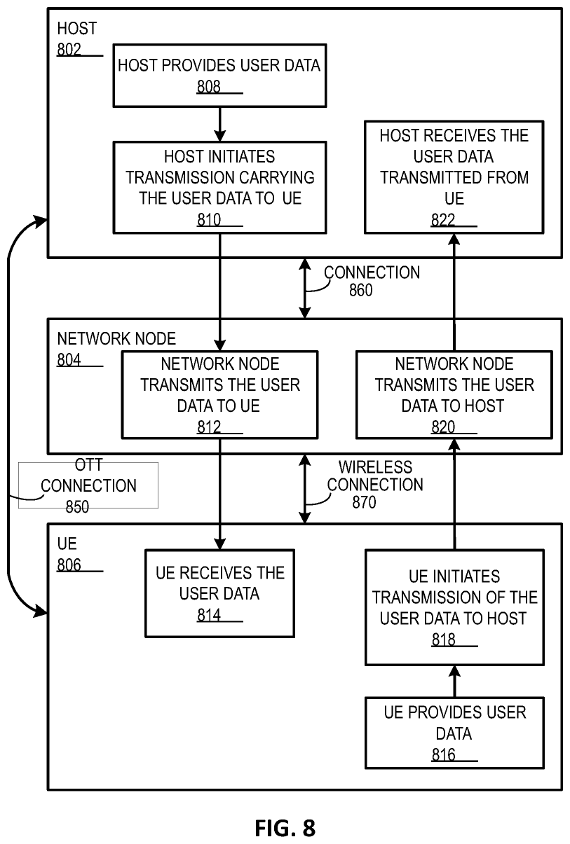

FIG. 8 shows a communication diagram of a host 802 communicating via a network node 804 with a UE 806 over a partially wireless connection in accordance with some embodiments. Example implementations, in accordance with various embodiments, of the UE (such as a UE 712a of FIG. 7), and host (such as host 716 of FIG. 7) discussed in the preceding paragraphs will now be described with reference to FIG. 8.

Embodiments of host 802 include hardware, such as a communication interface, processing circuitry, and memory. The host 802 also includes software, which is stored in or accessible by the host 802 and executable by the processing circuitry. The software includes a host application that may be operable to provide a service to a remote user, such as the UE 806 connecting via an over-the-top (OTT) connection 850 extending between the UE 806 and host 802. In providing the service to the remote user, a host application may provide user data which is transmitted using the OTT connection 850.

The network node 804 includes hardware enabling it to communicate with the host 802 and UE 806. The connection 860 may be direct or pass through a core network (like core network 706 of FIG. 7) and/or one or more other intermediate networks, such as one or more public, private, or hosted networks. For example, an intermediate network may be a backbone network or the Internet.

The UE 806 includes hardware and software, which is stored in or accessible by UE 806 and executable by the UE's processing circuitry. The software includes a client application, such as a web browser or operator-specific “app” that may be operable to provide a service to a human or non-human user via UE 806 with the support of the host 802. In the host 802, an executing host application may communicate with the executing client application via the OTT connection 850 terminating at the UE 806 and host 802. In providing the service to the user, the UE's client application may receive request data from the host's host application and provide user data in response to the request data. The OTT connection 850 may transfer both the request data and the user data. The UE's client application may interact with the user to generate the user data that it provides to the host application through the OTT connection 850.

The OTT connection 850 may extend via a connection 860 between the host 802 and the network node 804 and via a wireless connection 870 between the network node 804 and the UE 806 to provide the connection between the host 802 and the UE 806. The connection 860 and wireless connection 870, over which the OTT connection 850 may be provided, have been drawn abstractly to illustrate the communication between the host 802 and the UE 806 via the network node 804, without explicit reference to any intermediary devices and the precise routing of messages via these devices.

As an example of transmitting data via the OTT connection 850, in step 808, the host 802 provides user data, which may be performed by executing a host application. In some embodiments, the user data is associated with a particular human user interacting with the UE 806. In other embodiments, the user data is associated with a UE 806 that shares data with the host 802 without explicit human interaction. In step 810, the host 802 initiates a transmission carrying the user data towards the UE 806. The host 802 may initiate the transmission responsive to a request transmitted by the UE 806. The request may be caused by human interaction with the UE 806 or by operation of the client application executing on the UE 806. The transmission may pass via the network node 804, in accordance with the teachings of the embodiments described throughout this disclosure. Accordingly, in step 812, the network node 804 transmits to the UE 806 the user data that was carried in the transmission that the host 802 initiated, in accordance with the teachings of the embodiments described throughout this disclosure. In step 814, the UE 806 receives the user data carried in the transmission, which may be performed by a client application executed on the UE 806 associated with the host application executed by the host 802.

In some examples, the UE 806 executes a client application which provides user data to the host 802. The user data may be provided in reaction or response to the data received from the host 802. Accordingly, in step 816, the UE 806 may provide user data, which may be performed by executing the client application. In providing the user data, the client application may further consider user input received from the user via an input/output interface of the UE 806. Regardless of the specific manner in which the user data was provided, the UE 806 initiates, in step 818, transmission of the user data towards the host 802 via the network node 804. In step 820, in accordance with the teachings of the embodiments described throughout this disclosure, the network node 804 receives user data from the UE 806 and initiates transmission of the received user data towards the host 802. In step 822, the host 802 receives the user data carried in the transmission initiated by the UE 806.

One or more of the various embodiments improve the performance of OTT services provided to the UE 806 using the OTT connection 850, in which the wireless connection 870 forms the last segment. For example, the various embodiments enable applications requiring deterministic inter-reception times/no jitter to use the wireless system, e.g. 5G system. Applications requiring low jitter, or applications that cannot sustain varying or sporadically too large inter-arrival times of packets can be supported. More precisely, the teachings of these embodiments may improve the periodicity of communications transmitted wirelessly and thereby provide benefits such as fewer communication dropouts or error conditions, etc.

In an example scenario, factory status information may be collected and analysed by the host 802. As another example, the host 802 may process audio and video data which may have been retrieved from a UE for use in creating maps. As another example, the host 802 may collect and analyse real-time data to assist in controlling vehicle congestion (e.g., controlling traffic lights). As another example, the host 802 may store surveillance video uploaded by a UE. As another example, the host 802 may store or control access to media content such as video, audio, VR or AR which it can broadcast, multicast or unicast to UEs. As other examples, the host 802 may be used for energy pricing, remote control of non-time critical electrical load to balance power generation needs, location services, presentation services (such as compiling diagrams etc. from data collected from remote devices), or any other function of collecting, retrieving, storing, analysing and/or transmitting data.

In some examples, a measurement procedure may be provided for the purpose of monitoring data rate, latency and other factors on which the one or more embodiments improve. There may further be an optional network functionality for reconfiguring the OTT connection 850 between the host 802 and UE 806, in response to variations in the measurement results. The measurement procedure and/or the network functionality for reconfiguring the OTT connection may be implemented in software and hardware of the host 802 and/or UE 806. In some embodiments, sensors (not shown) may be deployed in or in association with other devices through which the OTT connection 850 passes; the sensors may participate in the measurement procedure by supplying values of the monitored quantities exemplified above, or supplying values of other physical quantities from which software may compute or estimate the monitored quantities. The reconfiguring of the OTT connection 850 may include message format, retransmission settings, preferred routing etc.; the reconfiguring need not directly alter the operation of the network node 804. Such procedures and functionalities may be known and practiced in the art. In certain embodiments, measurements may involve proprietary UE signalling that facilitates measurements of throughput, propagation times, latency and the like, by the host 802. The measurements may be implemented in that software causes messages to be transmitted, in particular empty or ‘dummy’ messages, using the OTT connection 850 while monitoring propagation times, errors, etc.

It should be noted that the above-mentioned examples illustrate rather than limit the invention, and that those skilled in the art will be able to design many alternative examples without departing from the scope of the appended statements. The word “comprising” does not exclude the presence of elements or steps other than those listed in a claim, “a” or “an” does not exclude a plurality, and a single processor or other unit may fulfil the functions of several units recited in the statements below. Where the terms, “first”, “second” etc. are used they are to be understood merely as labels for the convenient identification of a particular feature. In particular, they are not to be interpreted as describing the first or the second feature of a plurality of such features (i.e. the first or second of such features to occur in time or space) unless explicitly stated otherwise. Steps in the methods disclosed herein may be carried out in any order unless expressly otherwise stated. Any reference signs in the statements shall not be construed so as to limit their scope.

1.-43. (canceled)

44. A method performed by a receiver of receiving packets, the method comprising:
receiving packets, wherein each packet includes an identifier that identifies a respective group of a plurality of groups:
buffering the packets in a buffer; and
delivering the packets from the buffer to a higher layer or application;
wherein delivering the packets to a higher layer or application comprises delivering each packet in a delivery time period associated with the group identified by the identifier of the packet, wherein the delivery time period is based on a time sensitive communication assistance information, TSCAI.

45. The method of claim 44, wherein the time periods associated with the plurality of groups are different.

46. The method of claim 44, wherein delivering each packet in the delivery time period associated with the group identified by the identifier of the packet comprises delivering packets that identify a particular group at a predetermined time within the time period associated with the group or at an end of the time period associated with the group.

47. The method of claim 44, wherein the identifier for each packet is contained within a Packet Data Convergence Protocol, PDCP, header of the packet.

48. The method of claim 44, comprising receiving, from a base station, a configuration of at least one of a duration of each of the delivery time periods and a configuration of a start time or offset of one or more of the delivery time periods, obtained from the TSCAI.

49. The method of claim 44, comprising transmitting, to a transmitter of the packets, a configuration of a duration of each of the delivery time periods and/or a configuration of a start time or offset of one or more of the delivery time periods.

50. The method of claim 44, wherein the method is performed by a user equipment, UE.

51. The method of claim 44, wherein the method is performed by a base station.

52. A method of transmitting packets, the method comprising:
obtaining packets for transmission, wherein each packet is obtained in one of a plurality of time periods; and
transmitting the packets to a receiver such that each packet includes an identifier that identifies a respective group of a plurality of groups, wherein each group is associated with a respective one of the time periods wherein delivering the packets to a higher layer or application in the receiver is performed in a delivery time period based on a time sensitive communication assistance information, TSCAI.

53. The method of claim 52, wherein the plurality of groups comprise only a first group and a second group, wherein the first group is associated with a first one of the time periods and the second group is associated with a second one of the time periods.

54. The method of claim 52, comprising transmitting, to the receiver, at least one of a configuration of a duration of delivery time periods for delivering the packets to a higher layer or application in the receiver and/or a configuration of a start time or offset of one or more of the delivery time periods.

55. The method of claim 52, wherein transmitting each packet to the receiver such that each packet includes the identifier that identifies the respective group comprises inserting the identifier to a Packet Data Convergence Protocol, PDCP, header of the packet.

56. The method of claim 52, comprising receiving, from the receiver, at least one of a configuration of a duration of delivery time periods for delivering the packets to a higher layer or application in the receiver and/or a configuration of a start time or offset of one or more of the delivery time periods, obtained from the TSCAI.

57. The method of claim 52, wherein the duration of the delivery time periods corresponds to a duration of the plurality of time periods in which the packets are available for transmission.

58. The method of claim 52, wherein the method is performed by a User Equipment, UE.

59. The method of claim 52, wherein the method is performed by a base station.

60. Apparatus for receiving packets, the apparatus comprising a processing circuitry and a memory, the memory containing instructions executable by the processing circuitry such that the apparatus is operable to:
receive packets, wherein each packet includes an identifier that identifies a respective group of a plurality of groups;
buffer the packets in a buffer; and
deliver the packets from the buffer to a higher layer or application;
wherein delivering the packets to a higher layer or application comprises delivering each packet in a delivery time period associated with the group identified by the identifier of the packet wherein the delivery time period is based on a time sensitive communication assistance information, TSCAI.

61. The apparatus of claim 60, wherein the apparatus comprises or is comprised in a base station or a user equipment, UE.

62. Apparatus for transmitting packets, the apparatus comprising a processing circuitry and a memory, the memory containing instructions executable by the processing circuitry such that the apparatus is operable to:
obtain packets for transmission, wherein each packet is obtained in one of a plurality of time periods; and
transmit the packets to a receiver such that each packet includes an identifier that identifies a respective group of a plurality of groups, wherein each group is associated with a respective one of the time periods wherein delivering the packets to a higher layer or application in the receiver is performed in a delivery time period based on a time sensitive communication assistance information, TSCAI.

63. The apparatus of claim 62, wherein the apparatus comprises or is comprised in a base station or a User Equipment, UE.
